(19) United States
(12) Patent Application Publication
(10) Pub. No.: US 2015/0217343 A1
(43) Pub. Date: Aug. 6, 2015

(54) Method for Treating Oil Refinery Equipment to Oxidize Pyrophoric Iron Sulfide

(71) Applicant: Refined Technologies Inc., Spring, TX (US)

(72) Inventor: Blake Montgomery, Spring, TX (US)

(21) Appl. No.: 14/616,142

(22) Filed: Feb. 6, 2015

Related U.S. Application Data
(60) Provisional application No. 61/936,772, filed on Feb. 6, 2014.

(51) Int. Cl. B08B 9/08; B08B 9/032

(52) U.S. Cl. CPC B08B 9/08; B08B 9/032

(57) ABSTRACT

Pyrophoric material such as iron sulfide is frequently found in refinery equipment. When the equipment is opened to the atmosphere for maintenance, an exothermic reaction may take place that can cause catastrophic damage. A process according to the invention for treating pyrophoric material uses the controlled introduction of an oxygen-containing gas to safely oxidize the pyrophoric material. The oxygen-containing gas may be air.

### CROSS-REFERENCE TO RELATED APPLICATIONS

This application claims the benefit of U.S. Provisional Application No. 61/936,772 filed on Feb. 6, 2014.

### STATEMENT REGARDING FEDERALLY SPONSORED RESEARCH OR DEVELOPMENT

Not Applicable

### BACKGROUND OF THE INVENTION

1. Field of the Invention

The present invention generally relates to cleaning equipment in oil refineries and the like. More particularly, it relates to the oxidative deactivation of pyrophoric iron sulfide in such equipment.

2. Description of the Related Art Including Information Disclosed Under 37 CFR 1.97 and 1.98

A pyrophoric substance is generally defined as one that ignites spontaneously in air at or below 55° C. (130° F.). Examples include iron sulfide and many reactive metals including uranium (especially when powdered or thinly sliced). Pyrophoric materials are often water-reactive as well and will ignite when they contact water or humid air.

Spontaneous ignition of iron sulfide either on the ground or inside equipment can occur in all refineries. If this occurs inside equipment such as columns, vessels, tanks and exchangers containing residual hydrocarbons and air, the resulting fire and possible explosion can be devastating.

Most commonly, pyrophoric iron fires occur during shutdowns when equipment and piping are opened for inspection or maintenance. Instances of fires in crude columns during turnarounds, explosions in sulfur, crude or asphalt storage tanks, overpressures in vessels, etc., due to pyrophoric iron ignition have been widely reported.

Iron sulfide is one such pyrophoric material that oxidizes exothermically when exposed to air. It can be found in solid iron sulfide scales in refinery units. These iron sulfide scales can be found in the form of pyrite, troilite, marcasite, or pyrrhotite, any of which will react in the presence of oxygen. These scales are formed by the conversion of iron oxide (rust) into iron sulfide in an oxygen-free atmosphere where hydrogen sulfide (H₂S) gas is present (or where the concentration of hydrogen sulfide exceeds that of oxygen). The reaction can be represented as:

Fe₂O₃(rust)+3H₂S→2FeS+3H₂O+S

These conditions commonly exist in closed, oil-processing equipment made from carbon steel and used to refine high-sulfur-containing feedstock. The individual crystals of pyrophoric iron sulfides are extremely finely divided, the result of which is that they have an enormous surface area-to-volume ratio.

When the iron sulfide crystal is subsequently exposed to air, it is oxidized back to iron oxide and either free sulfur or sulfur dioxide gas is formed. This reaction between iron sulfide and oxygen is accompanied by the generation of a considerable amount of heat. This rapid exothermic oxidation is known as pyrophoric oxidation and the heat it produces can ignite nearby flammable hydrocarbon-air mixtures. The reaction can generally be described by the following chemical equations:

4FeS+3O₂→2Fe₂O₃+4S+HEAT

4FeS+7O₂→2Fe₂O₃+4SO₂+HEAT

This pyrophoric iron sulfide (PIS) lies dormant in the equipment until the equipment is shut down and opened for service, exposing the PIS to air, allowing the exothermic process of rapid oxidation of the sulfides to oxides to occur.

To combat the effects of pyrophoric reactions, the industry has, in the past, employed several standard procedures:

1. Acid cleaning with a corrosion inhibitor and hydrogen sulfide suppressant.

The acid dissolves sulfide scale and releases hydrogen sulfide gas. Cleaning/treating with an acid solution can be both effective and inexpensive. However, there are problems with this approach:
Disposal of the resulting hydrogen sulfide gas can be problematic.
The potential for corrosion can be great when the system contains more than one alloy.

2. Chelating Solutions.

These are specially formulated, high-pH solutions that are effective at dissolving the sulfide deposits without emitting hydrogen sulfide. However, specially formulated chelation solutions for this application are costly.

3. Oxidizing Chemicals.

Oxidizing chemicals convert the sulfide to oxide. Potassium permanganate (KMnO₄) has been used commonly in the past to oxidize pyrophoric sulfide. Potassium permanganate (or sodium permanganate) can be added to the equipment in combination with a water rinse, following a chemical cleaning procedure.

Another problem common to all of the existing methods is related to the nature of the equipment to be treated and the nature of the treatment solution. The pyrophoric material will form on all surfaces where hydrogen sulfide comes in contact with iron oxide. These surfaces can be (and typically are) vertical walls and the underside of horizontal features inside the equipment. Prior methods have used liquid solutions that are difficult (if not impossible) to effectively treat these surfaces without filling the equipment completely with the solution. Much of the equipment in a refinery is not designed to support the weight imposed by a complete fill and disposal of the large quantity of residual effluent can be problematic. To address this problem, prior chemistries have been applied using steam to atomize or vaporize them so that once dispersed, they can contact all surfaces of the vessel. The problem with this method of application is that prior chemistries comprise simple mixtures of various constituents that tend to return to their constituent form when vaporized. Consequently, there can be no way to ensure that the proper ingredients are adequately applied.

Still another problem common to existing methods is the estimation and provisioning of an appropriate amount of chemical. Before vessels are opened to the atmosphere and inspected, there is no way to determine the amount of chemistry needed to treat them. As a result, either too much chemical is allocated (raising the cost of the project and producing an excessive amount of effluent), or insufficiently treating the pyrophoric material (potentially resulting in problematic combustion). This process of the present invention solves this problem inasmuch as there is virtually a limitless source of oxidizing air available to force the reaction to a satisfactory completion.

### BRIEF SUMMARY OF THE INVENTION

Conversion of iron sulfide (FeS) to iron sulfate (Fe₂O₃) occurs naturally as oxygen combines with the iron sulfide. Problems arise when the iron sulfide resides in the proximity of a sufficient quantity of oxygen in the presence of a combustible material. The process of the invention takes advantage of the natural tendency of iron sulfide to react with oxygen by controlling the rate at which the oxygen is introduced to the iron sulfide-contaminated equipment.

Controlled introduction of air into the vessel allows the pyrophoric oxidation reaction to proceed with decreased risk and without the need for a chemical oxidizer. Limiting the concentration of oxygen (air) produces a slower reaction which decreases the rate of heat generated. Also, controlling the oxygen concentration decreases the risk of fire since a certain oxygen concentration is needed for combustion. If an oxygen concentration of less than 10% (about half of the normal oxygen content of air) is maintained, most hydrocarbons will not ignite.

### BRIEF DESCRIPTION OF THE SEVERAL VIEWS OF THE DRAWING(S)

FIG. 1 is a schematic diagram of a generic process tower and certain ancillary equipment of the type to which the method of the invention is particularly applicable.

### DETAILED DESCRIPTION OF THE INVENTION

Any of several methods can be used to control the oxygen concentration in the system, any of which could be employed by the process of the present invention. All would serve the same purpose. After the process equipment is taken out of service and chemically cleaned to remove hydrocarbons, the entire system is rendered oxygen-free. The system may be left under a positive pressure with either de-aerated steam or nitrogen purging through the equipment. With the vessel cleaned of hydrocarbons and devoid of oxygen, air is metered into the vessel. The air can be injected from the atmosphere using a compressor or via a plant air system. The rate of introduction and mass of air are controlled such that a proper stoichiometric ratio is maintained having been predetermined by calculation based on the nitrogen purge rate and the configuration of the equipment. This rate may typically start at about a 5% oxygen level and may then be increased to about a 10% oxygen level once the system is stable and no CO is present. The majority of the pyrophoric treatment happens at this lower oxygen level to slow the pyrophoric reaction and thereby decrease the fire risk. After the 10% oxygen level is maintained for a sufficient period of time, the oxygen levels may be increased step-wise until full air oxygen levels are reached (i.e., about 21% O₂).

An example of the controlled air oxidation process according to one particular embodiment of the invention is as follows:

1. The equipment is de-inventoried of liquids.

2. A process such as one disclosed in U.S. Pat. No. 6,893,509 (the entire contents of which are hereby incorporated by reference) may be used to remove hydrocarbons and other contaminants from the equipment.

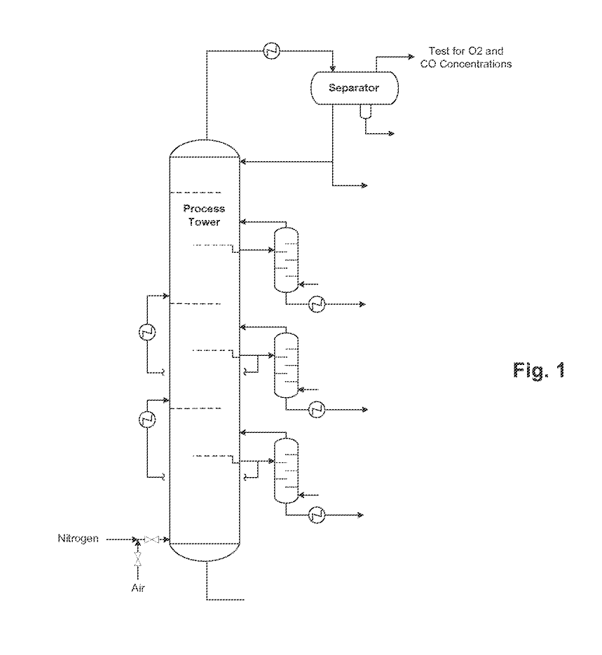

3. Without opening the equipment, nitrogen is applied (see valved “Nitrogen” inlet in FIG. 1) and any steam or other liquid or gas inputs are shut off while a positive pressure of approximately 5-10 psig is maintained.

4. Equipment with trays and other internals that could hold liquids are rinsed with water.

5. Liquid pyrophoric treatment (such as potassium permanganate) of any equipment with trays and other internals that could hold liquids is performed.

6. Required gas testing for lower explosive limit (LEL), H₂S, benzene and other contaminants is performed. LEL is the lowest concentration (percentage) of a gas or a vapor in air capable of producing a flash of fire in the presence of an ignition source (arc, flame, heat). The nitrogen sweep is maintained until these tests produce satisfactory results.

7. The system is blocked away from the flare and effluent system and vented to the atmosphere at a high point vent at the end of the circuit near the vent to flare points such as an overhead accumulator.

8. Compressed air is added to the nitrogen through a blend valve (see valved “Air” inlet in FIG. 1) to establish an air-to-nitrogen ratio of 1:3 by volume.

9. After a one-hour dwell period, the vents are checked for O₂ and CO (see representative test point in FIG. 1). If these levels are in the range of 5% oxygen and less than 10 ppm CO the air: nitrogen ratio is increased to 1:1.

10. After a two-hour dwell period, the vents are checked for O₂ and CO. If these levels are in the range of 10.5% oxygen and less than 10 ppm CO the air:nitrogen ratio is increased to 2:1.

11. After a one-hour dwell period, the vents are checked for O₂ and CO. If these levels are in the range of 14% oxygen and less than 10 ppm CO the air: nitrogen ratio is increased to 3:1.

12. After a one-hour dwell period, the vents are checked for O₂ and CO. If these levels are in the range of 16% oxygen and less than 10 ppm CO the nitrogen is shut off and a 100% air flow is established.

13. After a one-hour dwell period, the vents may be checked for O₂ and CO. If these levels are in the range of 21% oxygen and less than 10 ppm CO the pyrophoric treatment may be considered complete and maintenance activities, such as blinding and opening manways, can begin.

The foregoing presents particular embodiments of a system embodying the principles of the invention. Those skilled in the art will be able to devise alternatives and variations which, even if not explicitly disclosed herein, embody those principles and are thus within the invention's spirit and scope. Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. A method for treating equipment for pyrophoric iron sulfide contamination comprising:
filling the equipment with a mixture of oxygen and nitrogen at a preselected first ratio;
waiting a first period of time; and then,
filling the equipment with a mixture of oxygen and nitrogen at a preselected second ratio.

2. The method recited in claim 1 wherein the mixture of oxygen and nitrogen at a preselected first ratio is a mixture of air and nitrogen.

3. The method recited in claim 1 wherein the mixture of oxygen and nitrogen at a preselected second ratio is produced by injecting air into the equipment.

4. The method recited in claim 1 wherein the length of the first period of time is determined by testing the atmosphere within the equipment for oxygen concentration and carbon monoxide concentration.

5. The method recited in claim 1 further comprising substantially removing any hydrocarbons from the equipment prior to filling the equipment with the mixture of oxygen and nitrogen at the preselected first ratio.

6. The method recited in claim 5 wherein the hydrocarbons are removed by injecting a formulation comprising a non-aqueous, monocyclic, saturated terpene mixed with at least one non-ionic surfactant using high-pressure steam to form a cleaning vapor.

7. The method recited in claim 1 further comprising applying nitrogen to the equipment to maintain a positive pressure between about 5 and about 10 pounds per square inch prior to filling the equipment with the mixture of oxygen and nitrogen at the preselected first ratio.

8. The method recited in claim 1 further comprising rinsing internal features within the equipment that could hold liquids with water prior to filling the equipment with the mixture of oxygen and nitrogen at the preselected first ratio.

9. The method recited in claim 1 further comprising treating internal features within the equipment that could hold liquids with a liquid-phase oxidizing agent prior to filling the equipment with the mixture of oxygen and nitrogen at the preselected first ratio.

10. The method recited in claim 9 wherein the liquid-phase oxidizing agent comprises potassium permanganate.

11. The method recited in claim 9 wherein the liquid-phase oxidizing agent comprises sodium permanganate.

12. The method recited in claim 1 further comprising testing for lower explosive limit and sweeping the equipment with nitrogen until a preselected limit is reached prior to filling the equipment with the mixture of oxygen and nitrogen at the preselected first ratio.

13. The method recited in claim 1 further comprising testing for hydrogen sulfide and sweeping the equipment with nitrogen until a preselected limit is reached prior to filling the equipment with the mixture of oxygen and nitrogen at the preselected first ratio.

14. The method recited in claim 1 further comprising testing for benzene and sweeping the equipment with nitrogen until a preselected limit is reached prior to filling the equipment with the mixture of oxygen and nitrogen at the preselected first ratio.

15. The method recited in claim 1 wherein filling the equipment with a mixture of oxygen and nitrogen at a preselected first ratio comprises adding compressed air to the equipment through a blend valve to establish an air-to-nitrogen ratio of about 1:3 by volume.

16. The method recited in claim 1 wherein the first period of time is at least about one hour and the atmosphere within the equipment contains about 5% oxygen and less than about 10 ppm carbon monoxide and the second air-to-nitrogen ratio is about to 1:1.

17. The method recited in claim 16 further comprising:
waiting at least about two additional hours;
testing the atmosphere within the equipment for oxygen concentration and carbon monoxide concentration; and
increasing the air-to-nitrogen ratio to about 2:1 when the oxygen concentration is about 10.5% and the carbon monoxide concentration is less than about 10 ppm.

18. The method recited in claim 17 further comprising:
waiting at least about one additional hour;
testing the atmosphere within the equipment for oxygen concentration and carbon monoxide concentration; and
increasing the air-to-nitrogen ratio to about 3:1 when the oxygen concentration is about 14% and the carbon monoxide concentration is less than about 10 ppm.

19. The method recited in claim 18 further comprising:
waiting at least about one additional hour;
testing the atmosphere within the equipment for oxygen concentration and carbon monoxide concentration; and
changing the air-to-nitrogen ratio to 100% air when the oxygen concentration reaches about 16% and the carbon monoxide concentration is less than about 10 ppm.

20. The method recited in claim 19 further comprising:
waiting at least about one additional hour;
testing the atmosphere within the equipment for oxygen concentration and carbon monoxide concentration; and
opening the equipment to the atmosphere when the oxygen concentration reaches about 21% and the carbon monoxide concentration is less than about 10 ppm.
